(19) United States
(12) Patent Application Publication
(10) Pub. No.: US 2011/0163164 A1
(43) Pub. Date: Jul. 7, 2011

(54) Illuminative Article And Article Array, And Method And System For Illuminating Same

(76) Inventor: Matthew Gerald McNally, West Chester, OH (US)

(21) Appl. No.: 12/652,825

(22) Filed: Jan. 6, 2010

(51) Int. Cl. G06K 7/10; G06K 19/06

(52) U.S. Cl. 235/468; 235/491

(57) ABSTRACT

Embodiments of the present disclosure include an article comprising a product and one or more identifying marks associated with the product and comprising a photochromic ink which produces a photoluminescence in response to an external stimulus. Also provided is an array of packages and a merchandising system and method.

### FIELD OF THE INVENTION

The present disclosure generally relates to packaging and merchandising systems, methods of merchandising products, and point-of-sale devices that employ illuminative inks in the packaging of a consumer product.

### BACKGROUND OF THE INVENTION

Prospective buyers can face an overwhelming number of options when shopping for a specific consumer product. Manufacturers of consumer products generally include various color and graphic schemes to distinguish their goods from competing goods. Due to the large number of competing consumer products, however, the collection of different colors and graphics may tend to blend together in the eyes of a prospective buyer looking at the shelves containing the plethora of different products. The color and graphic schemes accordingly may contribute little to distinguishing competing products.

Accordingly, there may be a need to help consumers distinguish a product from competing products. There also may be a need for a merchandising system which can enable a consumer to easily identify a particular product.

### BRIEF DESCRIPTION OF THE DRAWINGS

FIG. 1 is a perspective view of an embodiment of a package for disposable absorbent articles.

FIG. 2 is an elevation view of an array of packages according to an embodiment.

FIG. 3 is a perspective view of an embodiment of a merchandise display system.

FIG. 4A is a perspective view of the merchandise display system of FIG. 3 with an array of packages with one set of packages illuminated.

FIG. 4B is a perspective view of the merchandise display system of FIG. 3 with an array of packages with another set of packages illuminated.

### DETAILED DESCRIPTION OF THE INVENTION

The present disclosure is directed to use of photochromic ink to produce a photoluminescence in packaging and merchandising systems, methods of merchandising products, and point-of-sale devices. For example, according to an embodiment, a product package may have associated therewith one or more identifying marks comprising a photochromic ink capable of producing photoluminescence in response to an external stimulus. The photoluminescence of the photochromic ink may be used to identify the product, enabling a consumer to identify the product among competing products. The present disclosure also is directed to embodiments including an array of packages of products, a merchandise display system for products, and methods for merchandising. Embodiments of such packaging, merchandising systems, and methods are described hereinbelow after the following definitions.

### DEFINITIONS

“Active region”, as used herein, means at least a portion of a packaging, which is provided with a photochromic ink which can photoluminesce in response to an external stimulus. There can be one or more active regions present on the packaging.

“Absorbent article” refers to devices that absorb and contain body exudates, and, more specifically, refers to devices that are placed against or in proximity to the body of the wearer to absorb and contain the various exudates discharged from the body. Absorbent articles may include diapers, training pants, adult incontinence undergarments, feminine hygiene products, breast pads, care mats, bibs, wound dressing products, and the like. As used herein, the term “body fluids” or “body exudates” includes, but is not limited to, urine, blood, vaginal discharges, breast milk, sweat and fecal matter.

“Comprise,” “comprising,” and “comprises” are open ended terms, each specifies the presence of what follows, e.g., a component, but does not preclude the presence of other features, e.g., elements, steps, components known in the art, or disclosed herein.

“Consisting essentially of” is used herein to limit the scope of subject matter, such as that in a claim, to the specified materials or steps and those that do not materially affect the basic and novel characteristics of the subject matter.

“Disposable” is used in its ordinary sense to mean an article that is disposed or discarded after a limited number of usage events over varying lengths of time, such as less than about 20 events, or less than about 10 events, or less than about 5 events, or less than about 2 events.

“Diaper” refers to an absorbent article generally worn by infants and incontinent persons about the lower torso so as to encircle the waist and legs of the wearer and that is specifically adapted to receive and contain urinary and fecal waste. As used herein, the term “diaper” also includes “pants” which is defined below.

“Indicia”, as used herein, means an identifying mark, including text and/or graphics, that can be used to convey a message. The message conveyed can be an indication of source, the characteristics of a product in a package, the quantity of a product in a package, the quality of a product in a package, or any other message.

“Ink”, as used herein, refers to a colored, usually liquid, material for writing and printing.

“Packaging”, as used herein, means a structure or material that is at least partially disposed on or about a product when the product is presented to the public.

“Pant” or “training pant”, as used herein, refer to disposable garments having a waist opening and leg openings designed for infant or adult wearers. A pant may be placed in position on the wearer by inserting the wearer's legs into the leg openings and sliding the pant into position about a wearer's lower torso. A pant may be preformed by any suitable technique including, but not limited to, joining together portions of the article using refastenable and/or non-refastenable bonds (e.g., seam, weld, adhesive, cohesive bond, fastener, etc.). A pant may be preformed anywhere along the circumference of the article (e.g., side fastened, front waist fastened). While the terms “pant” or “pants” are used herein, pants are also commonly referred to as “closed diapers”, “prefastened diapers”, “pull-on diapers”, “training pants”, and “diaper-pants”. Suitable pants are disclosed in U.S. Pat. No. 5,246,433, issued to Hasse, et al. on Sep. 21, 1993; U.S. Pat. No. 5,569,234, issued to Buell et al. on Oct. 29, 1996; U.S. Pat. No. 6,120,487, issued to Ashton on Sep. 19, 2000; U.S. Pat. No. 6,120,489, issued to Johnson et al. on Sep. 19, 2000; U.S. Pat. No. 4,940,464, issued to Van Gompel et al. on Jul. 10, 1990; U.S. Pat. No. 5,092,861, issued to Nomura et al. on Mar. 3, 1992; U.S. Patent Publication No. 2003/0233082 A1, entitled “Highly Flexible And Low Deformation Fastening Device”, filed on Jun. 13, 2002; U.S. Pat. No. 5,897,545, issued to Kline et al. on Apr. 27, 1999; U.S. Pat. No. 5,957,908, issued to Kline et al on Sep. 28, 1999.

“Photochromic material”, as used herein, means a material which undergoes a reversible photochemical reaction upon absorption of electromagnetic radiation. “Photochromic ink”, as used herein, means an ink which includes a photochromic material.

“Photoluminescence” or “photoluminesce”, as used herein, means the absorption of and release or emission of electromagnetic radiation.

### Illuminescent Articles

The articles embodied in the present disclosure incorporate photochromic materials which photoluminesce in response to an external stimulus. The photoluminescence of the photochromic materials may aid the consumer in distinguishing between different products.

In an embodiment, an article may comprise a product and one or more identifying marks associated with the product. The one of more identifying marks may comprise a photochromic ink which produces a photoluminescence in response to an external stimulus. Thus, in one embodiment, the one or more identifying marks comprising photochromic ink may be displayed directly on the product. In another embodiment; however, the article may further comprise a packaging material with the product disposed in the packaging material and the packaging material comprising at least one active region comprising the one or more identifying marks.

In an embodiment comprising packaging material, the packaging material may comprise a structure or material that is at least partially disposed on or about a product or a plurality of products. For example, in some embodiments the articles provided herein may comprise packages comprising a plurality disposable absorbent articles. Such packages may take any suitable structure known in the art. In certain embodiments the package can be a flexible plastic film bag or a rigid cardboard box in which a plurality of disposable absorbent articles are disposed. The package also may be in the form of an individual wrapper or pouch in which a single disposable absorbent article is disposed. Those skilled in the art will appreciate that although the packages described herein generally are described with respect to disposable absorbent articles, the packages also may be used with any other suitable product.

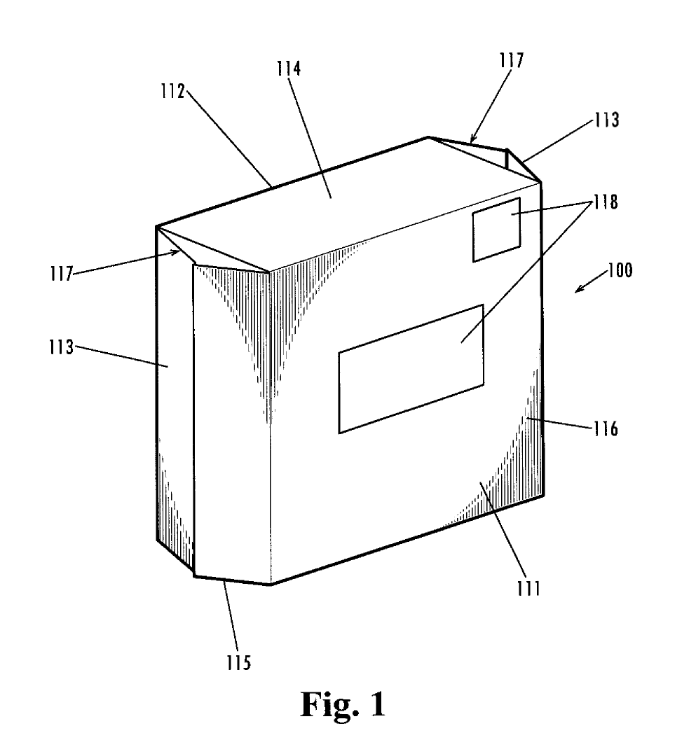

FIG. 1 illustrates a simplified perspective view of an embodiment of a package 100 for disposable absorbent articles (not shown) (i.e., a packaged absorbent product). The package 100 contains a plurality of disposable absorbent articles which can be stacked to form at least one stack in the package 100. The package 100 includes a front panel 111, a rear panel 112 opposed to the front panel 111, side panels 113 which connect the front and rear panels 111 and 112, a top panel 114 which connects the front, rear, and side panels 111, 112 and 113, and a bottom panel 115 opposed to the top panel 114. Each pair of the front and rear panels 111 and 112, the side panels 113 and the top and bottom panels 114 and 115 can be substantially planar as shown in FIG. 1. These panels 111-115 form an outer surface 116 of the package 100.

In embodiments, the package 100 shown in FIG. 1 can be a flexible bag which can be formed from a continuous tube of a thin plastic film material. The side portions of the package 100 can be closed by forming gusset structures 117 at the side panels 113.

The package 100 may include the same type, design and size of disposable absorbent articles. Alternatively, the package 100 may include two (or more) different types, designs and/or sizes of absorbent articles.

In certain embodiments, at least some of the disposable absorbent articles include either an individual flexible wrapper structure or a pouch structure which wraps or contains the respective absorbent article. In certain embodiments, some or all of the disposable absorbent articles can be stacked and stored in the package 100 without being individually wrapped or contained by a flexible wrapper or pouch.

Each of the disposable absorbent articles can be stored in the package 100 with or without being folded. In certain embodiments, at least a part of each disposable absorbent article can be folded inwardly. The folding operation for the absorbent articles can be carried out before or when the absorbent articles are stored in the package 100 or the flexible wrapper or pouch. For example, when the disposable absorbent articles are diapers, each diaper can be folded along one or two (or more if desired) folding lines so that the diaper can be folded into at least two (or three) sections which are defined by the folding line(s).

In certain embodiments, the package may be formed by a thin film material formed by a thermoplastic polymer(s). Such packages can be biodegradable, non-biodegradable, non-recyclable, or recyclable. The packages also may be formed of paper, or any recyclable material and laminate structures comprised of two or more of the aforementioned materials.

Suitable thermoplastic polymers for the packages include polyolefins such as polyethylene (PE), including a liner low density polyethylene (LLDPE), a low density polyethylene (LDPE), a ultra low density polyethylene (ULDPE), a high density polyethylene (HDPE), a polypropylene, and a mixture thereof. Other suitable thermoplastic polymers which also may be used include, but are not limited, to a polyester, a polyurethane, a compostable or biodegradable polymer, a thermoplastic elastomer, and a metallocene catalyst-based polymer.

In certain embodiments, the packages 100 further include one or more identifying marks such as one or more indicia 118 disposed on the outer surface 16 of the package 100. In a certain embodiment, the indicia 118 may be formed by a printed ink layer on the outer surface 116 of the package 100. In embodiments, the indicia 118 may be formed as an integral part of the package 100.

The printed ink layer may be formed using any suitable technique. Conventional printing methods known in the art include gravure printing, flexography printing, letter press printing, offset printing, ink jet printing, and the like. In an embodiment, the printed ink layer may be used to identify one or more indicia of the product. Furthermore, in accordance with certain embodiments, the one or more identifying marks may identify a source of the product, a characteristic of the product, the quantity of the product disposed in a package, or a combination thereof. Examples of indicia which may be included for the characterization of disposable absorbent articles include the brand name, the brand logo, the wearer's stage of development (for example, pre-locomotive or toddler), and the wearer's size (for example, newborn, size 3, small, or large). In an embodiment, the one or more indicia 118 comprise an active region which may be formed using a photochromic material capable of photoluminescing in response to an external stimulus.

### Photochromic Material

Photochromic materials generally are known. In embodiments, an ink formulation containing one or more photochromic materials can be used. The photochromic material can be in the form of fine pigment particles or dyes. Non-limiting examples of photochromic materials suitable herein are described in U.S. Patent Publication No. 2002/0195586, entitled “Homogenous Photosensitive Optically Variable Ink Compositions for Ink Jet Printing,” filed on May 9, 2002; and U.S. Patent Publication No. 2003/0041774, entitled “Photosensitive Optically Variable Ink Heterogeneous Compositions for Ink Jet Printing,” filed on Apr. 10, 2002.

In an embodiment, the photochromic material photoluminesces in response to an external stimulus. The photoluminescence may be in the form of fluorescence (release of the absorbed energy at a different frequency), phosphorescence (gradual release of the absorbed energy at the same frequency), or a combination thereof. The external stimulus may comprise electromagnetic radiation (i.e., light). The electromagnetic radiation may have a wavelength in the range of about 100 nm to about 700 nm. For example, in some embodiments the external stimulus may comprise electromagnetic radiation having a wavelength in the ultraviolet spectrum from about 100 nm to about 400 nm and in some embodiments the external stimulus may comprise electromagnetic radiation having a wavelength in the visible spectrum from about 400 nm to about 700 nm.

Those of skill in the art will appreciate that different types of photochromic materials absorb electromagnetic radiation of different wavelengths. In certain embodiments the photochromic material used to identify one or more indicia on a package may be selected based upon the absorbed wavelength of electromagnetic radiation capable of producing photoluminescence of the photochromic material. For example, the photochromic material may be selected so that it photoluminesces upon exposure to a particular wavelength of electromagnetic radiation, but does not photoluminesce when exposed to different particular wavelength of electromagnetic radiation. Selection of the photochromic material based on its response to different wavelengths of electromagnetic radiation will permit use of photochromic materials which may or may not photoluminesce when exposed to conventional retail lighting.

In certain embodiments, two or more different photochromic materials may be used to identify two or more different indicia on a package (i.e., brand and size), such that the photochromic material used to mark each indicia photoluminesces in response to a different wavelength of electromagnetic radiation. For example, a first photochromic material may be used to identify a first indicia on a package while a second photochromic material may be used to identify a second indicia on either the same package or a different package. In an embodiment, a first photochromic material may photoluminesce when irradiated with a first wavelength of electromagnetic radiation, but not a second wavelength of electromagnetic radiation different from the first wavelength of electromagnetic radiation and a second photochromic material may photoluminesce when irradiated with the second wavelength of electromagnetic radiation, but not the first wavelength of electromagnetic radiation. In such an embodiment, a first package marked with a first indicia comprising the first photochromic material illuminates when irradiated with the first wavelength of electromagnetic radiation, but not the second wavelength of electromagnetic radiation and a second packaged marked with a second indicia comprising the second photochromic material illuminates when irradiated with the second wavelength of electromagnetic radiation, but not the first wavelength of electromagnetic radiation. While not wishing to be bound by any theory, it is believed that using different types of photochromic materials to identify indicia on different packages will enable consumers to more easily identify a particular product.

### Array of Packages

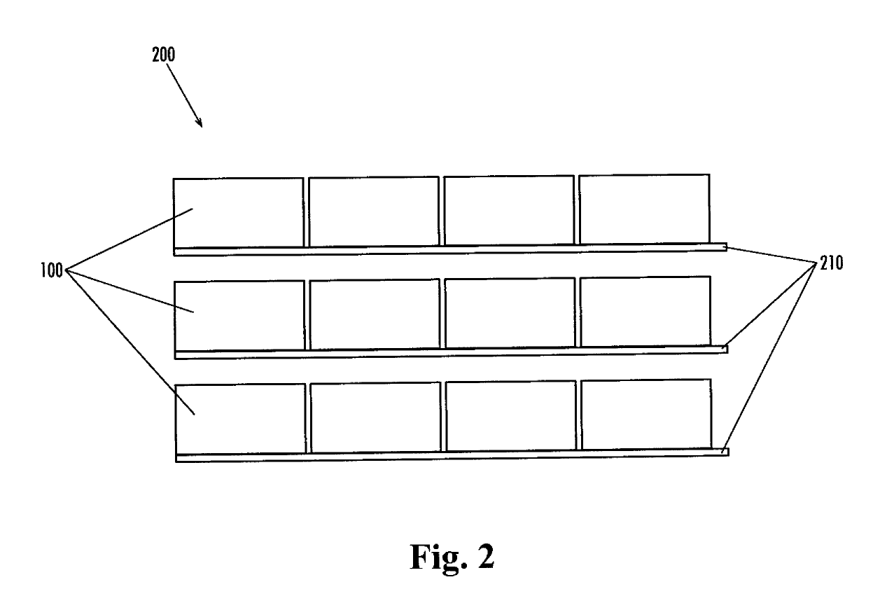

According to an embodiment, the articles provided herein may form part of an array of articles. FIG. 2 shows a simplified plan view of an array 200 of packages 100 arranged on a series of shelves 210. The packages 100 may be arranged according to any suitable criteria. The array 200 may include products of different types such as products having different characteristics or sources. For example, disposable absorbent articles may be arranged according to the manufacturer, brand, or diaper size.

In an embodiment, the array 200 may include a plurality of packages 100 comprising at least a first package and a second package. The product of the first package may comprise a first product and the product of the second package may comprise a second product different from the first product. To allow a consumer to select one type of product over another, at least a portion of the photochromic ink of the first article may identify a first indicia and the photoluminescence of the portion of the photochromic ink of the first package may be produced in response to the first external stimulus. Likewise, at least a portion of the photochromic ink of the second package may identify a second indicia and the photoluminescence of the portion of the photochromic ink of the second package may be produced in response to the second external stimulus. The first indicia may identify the first product and the second indicia may identify the second product. The external stimulus may comprise a radiation source. The first external stimulus may include radiation having a first wavelength, and the second external stimulus may include radiation having a second wavelength different than the first wavelength. In an embodiment, the first indicia may not produce the photoluminescence in response to the second external stimulus and the second indicia may not produce the photoluminescence in response to the first external stimulus. A system and method for selecting one product out of the plurality of products is described below.

### Merchandise Display System

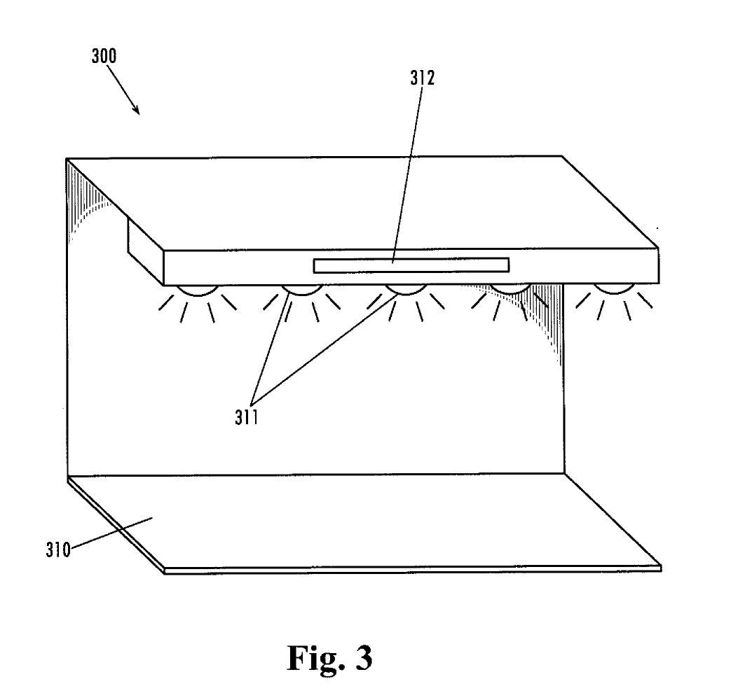

Also provided in embodiments is a merchandising system for displaying packages of products. FIG. 3 illustrates a simplified perspective view of a merchandise display system 300. The merchandise display system 300 generally comprises a display 310 on which products may be disposed such as in an array 200 illustrated in FIG. 2. For example, the display 310 may include one or more shelves.

In certain embodiments the merchandise display system 300 further may comprise a source of external stimulus such as a light source 311. The light source 311 may comprise any source of light capable of emitting electromagnetic radiation at a wavelength from about 100 nm to about 700 nm. In certain embodiments, the merchandise display system 300 may comprise two or more light sources 311 which emit electromagnetic radiation at two or more different wavelengths.

In certain embodiments the merchandise display system 310 further may comprise an activator such as a light source activator 312 for activation of the source of external stimulus such as the light source 311. The light source activator 312 may comprise any suitable means of turning on the light source 311. Non-limiting examples of suitable light source activators 312 include a switch, a button, a motion detector, a computer interface, or a combination thereof.

In some embodiments, the activator permits a consumer to make a selection and in response to the selection activates the source so that the source produces the external stimulus, such as light, and causes the photoluminescence of at least a portion of the photochromic ink when the plurality of articles are arranged in the array on the display. In a certain embodiment, the external stimulus includes a first external stimulus and a second external stimulus different from the first external stimulus and the external stimulus activator permits the consumer to make a first selection, and alternatively, permits the consumer to make a second selection, such that when the plurality of packages comprise at least a first package and a second package, the product of the first package comprises a first product and the product of the second package comprises a second product, the one or more identifying marks comprise a first indicia identifying the first product and a second indicia identifying the second product, the photoluminescence of the first indicia is produced in response to the first external stimulus, and the photoluminescence of the second indicia is produced in response to the second external stimulus, the activator, in response to the first selection, activates the source so that the source produces the first external stimulus and results in the photoluminescence of the first indicia, and, in response to the second selection, activates the source so that the source produces the second external stimulus and results in the photoluminescence of the second indicia. In a particular embodiment, the first indicia does not produce the photoluminescence in response to the second external stimulus and the second indicia does not produce the photoluminescence in response to the first external stimulus. Such embodiments allow a customer to relatively quickly select one product out of a plurality of products displayed in an array.

In certain embodiments in which the light source activator comprises a computer interface, the computer interface may comprise an interactive device which permits a consumer to input a specific product or features of products or the like. In this embodiment, the computer interface may activate the light source to produce photoluminescence of the photochromic ink on one or more products which correspond to the consumer input, but not the photochromic ink that is on other products that do not correspond to the consumer input or the electromagnetic radiation emitted from the light source.

Also provided is a method for illuminating a product in a merchandise display system. In an embodiment, a plurality of articles or packages as described hereinabove are arranged in an array on a display and at least one product is selected using an activator to create an external stimulus capable of producing a photoluminescence of at least a portion of the photochromic ink on the at least one product. In a particular embodiment, the external stimulus includes a first external stimulus and a second external stimulus different from the first external stimulus, the plurality of packages comprise at least a first package and a second package, the product of the first package comprising a first product and the product of the second package comprising a second product, the one or more identifying marks comprise a first indicia and a second indicia, the photoluminescence of the first indicia is produced in response to the first external stimulus and the photoluminescence of the second indicia is produced in response to the second external stimulus, the first indicia identifying the first product and the second indicia identifying the second product, and the selecting step comprises a consumer making a first selection with the activator and the activator, in response to the first selection, activating the source so that the source produces the first external stimulus and causes the photoluminescence of the first indicia, and alternatively, the consumer to making a second selection with the activator and the activator, in response to the second selection, activating the source so that the source produces the second external stimulus and causes the photoluminescence of the second indicia. In a certain embodiment, the first indicia identifies a first product, the second indicia identifies a second product, and the second product is different from the first product. In a particular embodiment, the first indicia does not produce the photoluminescence in response to the second external stimulus and the second indicia does not produce the photoluminescence in response to the first external stimulus.

In a certain embodiment, the method for illuminating a product comprises selecting at least one product using a computer interface. The computer interface may prompt a consumer to actively input answers to questions regarding the pertinent characteristics of the product or may prompt a consumer to actively input the identity of a specific product. For example, in certain embodiments the prompts may permit a consumer to input information regarding the desired manufacturer, desired brand, or desired size of a diaper. Upon receipt of the consumer input, the computer interface may activate a light source to create an external stimulus capable of producing photoluminescence of the photochromic ink on one or more products which correspond to the consumer input, but not other products marked with photochromic ink that do not correspond to the consumer input or the electromagnetic radiation emitted from the light source.

The foregoing disclosure may be better understood by making reference now to the following prophetic examples, which are provided by way of explanation of embodiments of the disclosure, not limitation of the disclosure.

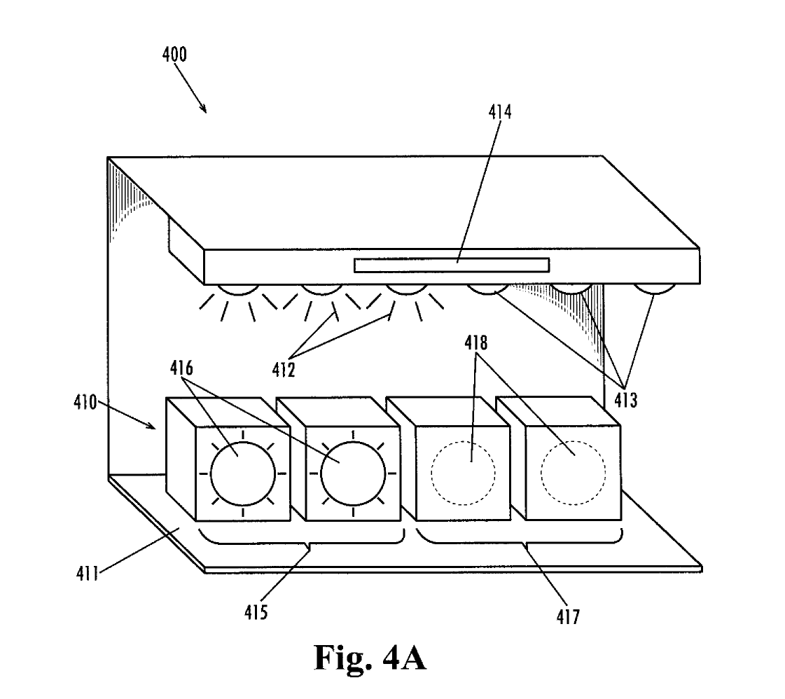

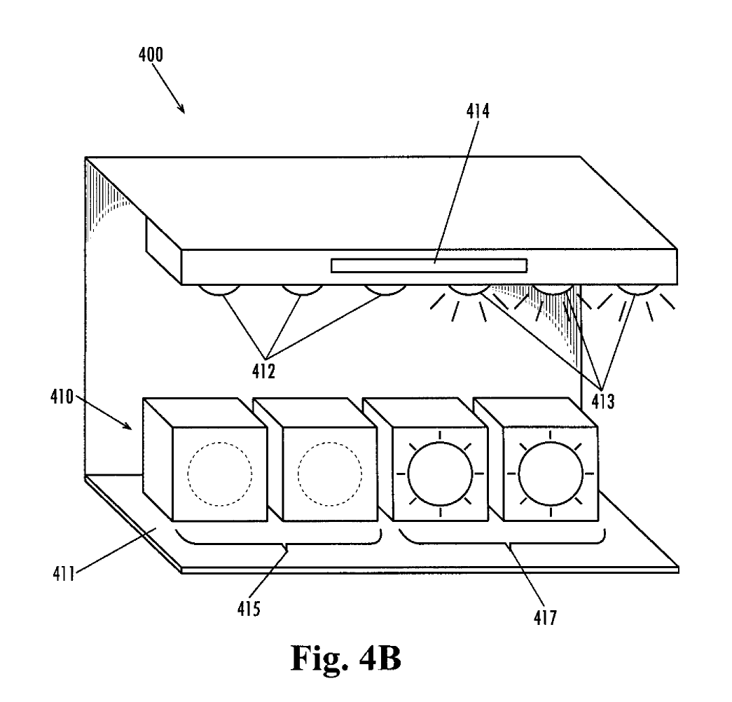

FIGS. 4A and 4B illustrate a simplified perspective view of a merchandise display system 400 with an array of packages 410 on a display shelf 411. The merchandise display system 400 further may comprise a first light source 412 and a second light source 413 which emit a first wavelength of electromagnetic radiation and a second wavelength of electromagnetic radiation, respectively, the second wavelength of electromagnetic radiation being different than the first wavelength of electromagnetic radiation. The merchandise display system 400 may further comprise a light source activator 414 for activation of the first and/or second light source(s) 412, 413.

The array of packages 410 disposed on the display shelf 411 of the merchandise display system 400 may comprise a first set of packages 415 marked with a first indicia 416 comprising a first photochromic material which photoluminesces when exposed to the first wavelength of electromagnetic radiation from the first light source 412, but not when exposed to the second wavelength of electromagnetic radiation from the second light source 413. The array of packages 410 disposed on the shelf 411 of the merchandise display system 400 may further comprise a second set of packages 417 marked with a second indicia 418 comprising a second photochromic material which photoluminesces when exposed to the second wavelength of electromagnetic radiation from the second light source 413, but not when exposed to the first wavelength of electromagnetic radiation from the first light source 412.

FIG. 4A illustrates photoluminescence of the first indicia 416 on the first set of packages 415 upon exposure to the first wavelength of electromagnetic radiation from the first light source 412 while FIG. 4B illustrates photoluminescence of the second indicia 418 on the second set of packages 415 upon exposure to the second wavelength of electromagnetic radiation from the second light source 412.

In embodiments, a consumer may use the merchandise display system 400 to identify a particular product using the light source activator 414 comprising a computer interface. The computer interface may prompt the consumer to actively input answers to questions regarding the pertinent characteristics of the product or may prompt a consumer to actively input the identity of a specific product. For example, the prompts may permit a consumer to select between products characterized by a first indicia 416 or a second indicia 418.

When the consumer selects the first indicia 416, the computer interface may activate the first light source 412 to emit the first wavelength of electromagnetic radiation. Upon exposure to the first wavelength of electromagnetic radiation, the photochromic ink of the first indicia 416 on the first set of packages 415 of the array 410 photoluminesces while the photochromic ink of the second indicia 418 on the second set of packages 417 does not photoluminesce. Alternatively, when the consumer selects the second indicia 416, the computer interface may activate the second light source 413 to emit the second wavelength of electromagnetic radiation. Upon exposure to the second wavelength of electromagnetic radiation, the photochromic ink of the second indicia 418 on the second set of packages 417 of the array 410 photoluminesces while the photochromic ink of the first indicia 416 on the first set of packages 415 does not photoluminesce.

All patents and patent applications (including any patents which issue thereon) assigned to the Procter & Gamble Company referred to herein are hereby incorporated by reference to the extent that it is consistent herewith.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article comprising:
a product; and
one or more identifying marks associated with the product and comprising a photochromic ink which produces a photoluminescence in response to an external stimulus.

2. The article of claim 1 further comprising a packaging material, the product disposed in the packaging material and the packaging material comprising at least one active region comprising the one or more identifying marks.

3. The article of claim 1, wherein the photoluminescence comprises phosphorescence, fluorescence, or a combination thereof.

4. The article of claim 1, wherein the external stimulus comprises a radiation source for emitting radiation having a wavelength in the range of about 100 nm to about 700 nm.

5. The article of claim 1, wherein the product comprises an absorbent article.

6. The article of claim 1, wherein one or more identifying marks identify a source of the product, a characteristic of the product, the quantity of the product disposed in a package, or a combination thereof.

7. An array comprising a plurality of articles arranged in an array and each article comprising a product and one or more identifying marks associated with the product and comprising photochromic ink which produces a photoluminescence in response to an external stimulus.

8. The array of claim 7 wherein each article further comprises a packaging material, the product disposed in the packaging material and the packaging material comprising at least one active region comprising the one or more identifying marks.

9. The array of claim 7, wherein the external stimulus includes a first external stimulus and a second external stimulus different from the first external stimulus, and the one or more identifying marks comprise a first indicia and a second indicia, the photoluminescence of the first indicia is produced in response to the first external stimulus and the photoluminescence of the second indicia is produced in response to the second external stimulus.

10. The array of claim 7, wherein:
external stimulus includes a first external stimulus and a second external stimulus different from the first external stimulus;
the plurality of articles comprise at least a first article and a second article, the product of the first article comprising a first product and the product of the second article comprising a second product different from the first product;
at least a portion of the photochromic ink of the first article identifying a first indicia and the photoluminescence of the portion of the photochromic ink of the first article being produced in response to the first external stimulus;
at least a portion of the photochromic ink of the second article identifying a second indicia and the photoluminescence of the portion of the photochromic ink of the second article being produced in response to the second external stimulus; and
the first indicia identifying the first product and the second indicia identifying the second product.

11. The array of claim 7, wherein the external stimulus comprises a radiation source, the first external stimulus includes radiation having a first wavelength, and the second external stimulus includes radiation having a second wavelength different than the first wavelength.

12. The array of claim 9, wherein the first indicia and second indicia identify a source of the product, a characteristic of the product, a quantity of the product disposed in each package, or a combination thereof, wherein the first indicia is different from the second indicia.

13. The array of claim 9, wherein the first indicia does not produce the photoluminescence in response to the second external stimulus and the second indicia does not produce the photoluminescence in response to the first external stimulus.

14. The array of claim 7, wherein the external stimulus comprises a radiation source emitting radiation having a wavelength in the range of about 100 nm to about 700 nm.

15. The array of claim 7, wherein the product comprises an absorbent article.

16. A merchandising system comprising:
a display for a plurality of articles arranged in an array, each article comprising a product and one or more identifying marks associated with the product and comprising photochromic ink;
a source of external stimulus for causing the photochromic ink to produce a photoluminescence; and
an activator for activation of the source of external stimulus.

17. The system of claim 16, wherein the activator permits a consumer to make a selection and in response to the selection activates the source so that the source produces the external stimulus and results in the photoluminescence of at least a portion of the photochromic ink when the plurality of articles are arranged in the array on the display.

18. The system of claim 16, wherein;
the external stimulus includes a first external stimulus and a second external stimulus different from the first external stimulus; and
the activator permits the consumer to make a first selection, and alternatively, permits the consumer to make a second selection,
such that when the plurality of articles comprise at least a first article and a second article, the product of the first article comprises a first product and the product of the second article comprises a second product, the one or more identifying marks comprise a first indicia identifying the first product and a second indicia identifying the second product, the photoluminescence of the first indicia is produced in response to the first external stimulus, and the photoluminescence of the second indicia is produced in response to the second external stimulus,
the activator, in response to the first selection, activates the source so that the source produces the first external stimulus and results in the photoluminescence of the first indicia, and, in response to the second selection, activates the source so that the source produces the second external stimulus and results in the photoluminescence of the second indicia.

19. The system of claim 18, wherein the first indicia does not produce the photoluminescence in response to the second external stimulus and the second indicia does not produce the photoluminescence in response to the first external stimulus.

20. The system of claim 16, wherein the activator comprises a switch, a button, a motion detector, a computer interface, or a combination thereof.

21. The system of claim 16, wherein the one or more identifying marks identify a source of the product, a characteristic of the product, the quantity of the product disposed in each package, or a combination thereof.

22. The system of claim 16, wherein the product comprises an absorbent article.

23. The system of claim 16, wherein the source of external stimulus is a radiation source for producing radiation having a wavelength in the range of about 100 nm to about 700 nm.

24. The system of claim 16, further comprising the plurality of articles arranged in the array on the display.

25. The system of claim 24, wherein the activator permits a consumer to make a selection and in response to the selection activates the source so that the source produces the external stimulus and results in the photoluminescence of at least a portion of the photochromic ink.

26. The system of claim 24, wherein;
the external stimulus includes a first external stimulus and a second external stimulus different from the first external stimulus;
the plurality of articles comprise at least a first article and a second article, the product of the first article comprising a first product and the product of the second article comprising a second product;
the one or more identifying marks comprise a first indicia and a second indicia, the photoluminescence of the first indicia is produced in response to the first external stimulus and the photoluminescence of the second indicia is produced in response to the second external stimulus;
the first indicia identifying the first product and the second indicia identifying the second product and the activator permits the consumer to make a first selection and, in response to the first selection, the activator activates the source so that the source produces the first external stimulus and results in the photoluminescence of the first indicia, and alternatively, permits the consumer to make a second selection and, in response to the second selection, the activator activates the source so that the source produces the second external stimulus and results in the photoluminescence of the second indicia.

27. The system of claim 26, wherein the first indicia identifies a first product, the second indicia identifies a second product, and the second product is different from the first product.

28. The system of claim 26, wherein the first indicia does not produce the photoluminescence in response to the second external stimulus and the second indicia does not produce the photoluminescence in response to the first external stimulus.

29. The system of claim 24, wherein the activator comprises a switch, a button, a motion detector, a computer interface, or a combination thereof.

30. The system of claim 24, wherein the one or more identifying marks identify a source of the product, a characteristic of the product, the quantity of the product disposed in each package, or a combination thereof.

31. The system of claim 24, wherein the product comprises an absorbent article.

32. The system of claim 16, wherein the source of external stimulus is a radiation source for producing radiation having a wavelength in the range of about 100 nm to about 700 nm.

33. The system of claim 24 wherein each article further comprises a packaging material, the product disposed in the packaging material and the packaging material comprising at least one active region comprising the one or more identifying marks.

34. A merchandising method comprising:
providing a plurality of articles arranged in an array on a display, each article comprising a product and one or more identifying marks associated with the product and comprising photochromic ink;
selecting at least one product using an activator to create an external stimulus capable of producing a photoluminescence of at least a portion of the photochromic ink on the at least one product.

35. The method of claim 34, wherein;
the external stimulus includes a first external stimulus and a second external stimulus different from the first external stimulus;
the plurality of articles comprise at least a first article and a second article, the product of the first article comprising a first product and the product of the second article comprising a second product;
the one or more identifying marks comprise a first indicia and a second indicia, the photoluminescence of the first indicia is produced in response to the first external stimulus and the photoluminescence of the second indicia is produced in response to the second external stimulus;
the first indicia identifying the first product and the second indicia identifying the second product; and
the selecting step comprises a consumer making a first selection with the activator and the activator, in response to the first selection, activating the source so that the source produces the first external stimulus and causes the photoluminescence of the first indicia, and alternatively, the consumer to making a second selection with the activator and the activator, in response to the second selection, activating the source so that the source produces the second external stimulus and causes the photoluminescence of the second indicia.

36. The method of claim 35, wherein the first indicia identifies a first product, the second indicia identifies a second product, and the second product is different from the first product.

37. The method of claim 35, wherein the first indicia does not produce the photoluminescence in response to the second external stimulus and the second indicia does not produce the photoluminescence in response to the first external stimulus.

38. The method of claim 34, wherein the activator comprises a switch, a button, a motion detector, a computer interface, or a combination thereof.

39. The method of claim 34, wherein the one or more identifying marks identify a source of the product, a characteristic of the product, the quantity of the product disposed in each package, or a combination thereof.

40. The method of claim 34, wherein the product comprises an absorbent article.

41. The method of claim 34, wherein the source of external stimulus is a radiation source for producing radiation having a wavelength in the range of about 100 nm to about 700 nm.

42. The method of claim 34 wherein each article further comprises a packaging material, the product disposed in the packaging material and the packaging material comprising at least one active region comprising the one or more identifying marks.
